(19) United States
(12) Patent Application Publication
(10) Pub. No.: US 2021/0040673 A1
(43) Pub. Date: Feb. 11, 2021

(54) WASHING MACHINE

(71) Applicants: QINGDAO HAIER WASHING MACHINE CO., LTD., Shandong (CN); QINGDAO HAIER SMART TECHNOLOGY R&D CO., LTD., Shandong (CN); HAIER SMART HOME CO., LTD., Shandong (CN)

(72) Inventors: Di WU, Shandong (CN); Xinghui HAO, Shandong (CN); Chunfeng LAO, Shandong (CN)

(73) Assignees: QINGDAO HAIER WASHING MACHINE CO., LTD., Shandong (CN); QINGDAO HAIER SMART TECHNOLOGY R&D CO., LTD., Shandong (CN); HAIER SMART HOME CO., LTD., Shandong (CN)

(21) Appl. No.: 16/975,991

(22) PCT Filed: Feb. 15, 2019
(86) PCT No.: PCT/CN2019/075165

§ 371 Date: Aug. 26, 2020

(30) Foreign Application Priority Data
Feb. 27, 2018 (CN) 201810161895.5

(51) Int. Cl. D06F 39/08; D06F 23/04; D06F 37/26; F16J 15/06

(52) U.S. Cl. CPC D06F 39/083; D06F 39/081; F16J 15/06; D06F 37/26; D06F 23/04

(57) ABSTRACT

The present disclosure discloses a washing machine, including a water guide structure being a water guide chamber arranged on a tub wall of a washing tub and configured to guide washing water below the washing tub; a dehydration port arranged on the tub wall of the washing tub and configured to be communicated with the water guide structure; and a sealing structure arranged between the tub wall of the washing tub and the water guide structure and configured to prevent the washing water from splashing via a gap between the tub wall of the washing tub and the water guide structure. The present disclosure provides a washing machine with a water outlet at the top, and the drainage channel is closely connected with the washing tub, so as to ensure the drainage function, greatly increase the volume of the washing tub.

### TECHNICAL FIELD

The present disclosure belongs to the technical field of washing machines and specifically relates to a washing machine.

### BACKGROUND

A washing machine is designed as a device for washing clothes by using electricity. Generally speaking, the washing machine includes a tub for containing washing water; a rotating tub rotatably installed inside the tub; a pulsator rotatably installed at the bottom of the rotating tub; and a motor and a clutch, which are configured to drive the rotating tub and the pulsator to rotate. When the rotating tub and the pulsator rotate in a state in which the clothes and a detergent are introduced into the rotating tub, the pulsator and the clothes introduced into the rotating tub stir the washing water together to remove stains from the clothes. In order to increase the washing capacity of the washing machine, a larger rotating tub is required, that is, the height or diameter of the rotating tub needs to be increased. If the rotating tub has a larger size, a tub accommodating the rotating tub and a housing accommodating the tub also need to be increased with the increase of the rotating tub. At the same time, during the washing process of a traditional pulsator washing machine, an inner tub is communicated with an outer tub, water is contained in the inner tub and the outer tub, but only the water in the inner tub needs to be really used for washing the clothes, thereby causing the waste of the water. And furthermore, in the long-term use, dirt accumulates between the inner tub and the outer tub, bacteria breed, and the water exchange process between the inner tub and the outer tub will cause secondary pollution of the clothes, thus timely draining the washing water in the washing tub and avoiding the pollution to the internal space of the washing machine become an urgent problem to be solved.

The Chinese patent with the application number CN201621037656.1 discloses a pulsator washing machine, including a non-porous inner tub, a sealing disc and a driving device, a drainage hole is arranged in the tub bottom of the non-porous inner tub. At least part of the sealing disc is rotatably arranged at the bottom of the non-porous inner tub between an open position and a closed position relative to the non-porous inner tub. A water passage hole is arranged in the sealing disc, the water passage hole is communicated with the drainage hole when the sealing disc is located in the open position, the sealing disc closes the drainage hole when the sealing disc is located in the closed position, and a sealing disc is located on the inner side of the tub bottom of the non-porous inner tub. And the driving device is connected with the sealing disc and the non-porous inner tub respectively, and the driving device is used for driving the non-porous inner tub and the sealing disc to rotate and driving the sealing disc to rotate relative to the non-porous inner tub.

The Chinese patent with the application number CN201621037660.8 discloses a pulsator washing machine, including a non-porous inner tub, a sealing disc and a driving device, a drainage hole is arranged in the tub bottom of the non-porous inner tub. At least part of the sealing disc is rotatably arranged at the bottom of the non-porous inner tub between an open position and a closed position relative to the non-porous inner tub, a water passage hole is arranged in the sealing disc, the water passage hole is communicated with the drainage hole when the sealing disc is located in the open position, and the sealing disc closes the drainage hole when the sealing disc is located in the closed position. The driving device is connected with the sealing disc and the non-porous inner tub respectively, and the driving device is used for driving the non-porous inner tub and the sealing disc to rotate and driving the sealing disc to rotate relative to the non-porous inner tub.

Thus, it is necessary to improve the deficiencies and defects of the prior art and provide a washing machine with a water outlet at the top and arranges a drainage channel and a washing tub in a tight fit manner, so as to greatly increase the volume of the washing tub while ensure the drainage function, also ensure the degree of cleaning of internal space and further avoid the overflow of water from the dehydration port in the washing process.

### SUMMARY

The technical problems to be solved by the present disclosure are to overcome the shortcomings of the prior art and the present disclosure provides a washing machine which can overcome the above-mentioned problems or at least partially solve the above-mentioned problems.

In order to solve the above technical problems, the basic concept of the technical solution adopted by the present disclosure is as following:

a washing machine, comprises:

a water guide structure, being a structure of water guide chamber arranged on a tub wall of a washing tub and configured to guide washing water below the washing tub;

a dehydration port, arranged on the tub wall of the washing tub and configured to be communicated with the water guide structure; and

a sealing structure, arranged between the tub wall of the washing tub and the water guide structure and configured to prevent the washing water from splashing via a gap between the tub wall of the washing tub and the water guide structure.

Wherein, the washing tub is configured to be a tub body structure for holding the washing water in the washing process; and

a part of the tub wall of the washing tub below the dehydration port is impermeable.

In addition, the water guide structure is embedded in the outer wall of the washing tub and forms a smooth transitional curved surface with the outer wall of the washing tub. When the washing tub rotates at high speed, the smooth transitional curved surface can effectively reduce the resistance of wind, reduce the energy consumption and improve the washing efficiency.

Further, the water guide structure further includes a first water guide part which is touched with an outer side of the tub wall of the washing tub.

In an embodiment, a distance between the outer wall of the first water guide part and the axis of the washing tub increases gradually in the direction from the top to the bottom of the washing tub.

Even further, a second water guide part communicated with a water outlet end of the first water guide part is further included; and the second water guide part guides the washing water to the lower part of the washing tub.

In an embodiment, a distance between an outer wall of the second water guide part and the axis of the washing tub decreases gradually in the direction from the top to the bottom of the washing tub.

At the same time, the sealing structure is annularly arranged at an edge of the dehydration port and configured to ensure that the water guide chamber of the water guide structure is connected with the dehydration port of the washing tub in a sealed manner, so as to prevent the washing water from splashing via a gap between the dehydration port of the washing tub and the water guide structure.

In addition, the sealing structure is annularly arranged at the edge of the structure of the water guide structure embedded into the tub wall of the washing tub and configured to prevent the washing water from splashing via the gap of the water guide structure embedded into the tub wall of the washing tub.

In an embodiment, the sealing structure is a sealing ring annularly arranged at the edge of the dehydration port.

In an embodiment, the sealing structure is a sealant annularly arranged at the edge of the dehydration port.

Furthermore, a water collecting device for collecting the washing water drained from the water guide structure is arranged outside a bottom of the washing tub; an upper opening of the water collecting device is lower than the dehydration port of the washing tub; and a drainage channel for draining the water led out by the water guide structure is arranged on the water collecting device.

In an embodiment, the water collecting device is located below the washing tub and coaxially arranged with the washing tub.

Further, a concave water collecting groove is arranged on a bottom wall of the water collecting device; and the water collecting groove is circumferentially arranged along the bottom wall of the water collecting device.

Even further, the second water guide part of the water guide structure guides the washing water in the washing tub into the water collecting groove.

In an embodiment, an upper edge of the water collecting groove is higher than a water outlet end of the second water guide part.

In an embodiment, an upper edge of the water collecting groove is not higher than a position of one half of the height of the washing tub.

After adopting the above technical solution, compared with the prior art, the present disclosure has the following beneficial effects:

1. In the present disclosure, the dehydration port of the washing tub is arranged on the tub wall of the washing tub and simultaneously the water guide structure is arranged to be communicated with the dehydration port, which effectively utilizes the flow trend of the water flow during the dehydration of the washing tub and reduces the energy consumption while ensures the functions.

2. In the case that the volume of a housing is unchanged or changes a little, the capacity of the washing tub is increased, and the effect of expanding the capacity of the washing machine is realized.

3. In the washing process, the water only exists in the washing tub, the problem of “hiding dirt” between the inner wall of the outer tub and the outer wall of the washing tub caused by the water existence between the inner tub and the outer tub of the traditional washing machine is avoided, and the washing effect is better.

4. The outer tub is eliminated, the washing tub is a water holding tub, and the water does not exist between the inner tub and the outer tub in the washing process, thereby reducing the water consumption for washing and saving the water consumption for washing.

5. The bottom wall of the water collecting cavity of the water collecting device is provided with a water guide structure for guiding the water flow to the water outlet, so as to realize better water guiding and drainage, ensure water collection and drainage of the water collecting device and prevent the accumulated water from overflowing.

6. The multi-segment water guide structure utilizes the flow trend of the water in the washing tub rotating at a high speed, thereby preventing the water flow from reversing in the drainage process and simultaneously ensuring the centralized drainage of the water flow in the drainage process.

7. The sealing structure is arranged between the water guide structure and the tub wall of the washing tub, thereby effectively reducing the situation that the washing water in the tub splashes via the gap between the water guide structure and the tub wall of the washing tub in the process of the dehydration operation.

The specific embodiments of the present disclosure are further described below in detail in conjunction with the drawings.

### BRIEF DESCRIPTION OF THE DRAWINGS

The drawings as one part of the present disclosure are used to provide a further understanding of the present disclosure. The illustrative embodiments of the present disclosure and the description thereof are used for explaining the present disclosure and are not intended to improperly limit the present disclosure. It is obvious that the drawings in the following description are only some embodiments. For those of ordinary skill in the art, other drawings may also be obtained according to the drawings without creative labor.

In the drawings:

FIG. 1 is a first schematic diagram of the structure of a washing tub of a washing machine of the present disclosure;

FIG. 2 is a first amplified schematic diagram of a dehydration port of the washing tub of the present disclosure;

FIG. 3 is a first sectional schematic diagram of a water guide structure of the present disclosure;

FIG. 4 is a second schematic diagram of the structure of the washing tub of the washing machine of the present disclosure;

FIG. 5 is a second amplified schematic diagram of the dehydration port of the washing tub of the present disclosure;

FIG. 6 is a second sectional schematic diagram of the water guide structure of the present disclosure; and

FIG. 7 is a schematic diagram of a sealing structure of the washing machine of the present disclosure.

Wherein, 1: washing tub; 2: water guide structure; 3: dehydration port; 4: first water guide part; 5: second water guide part; 6: water collecting device; 7: drainage channel; 8: water collecting groove; 9: sealing structure; 10: locking structure; 11: balancing ring; 12: housing; and 13: valve plug.

It should be noted that these drawings and text descriptions are not intended to limit the scope of the concept of the present disclosure in any way, but to explain the concept of the present disclosure to those skilled in the art by referring to specific embodiments.

### DETAILED DESCRIPTION OF THE EMBODIMENTS

In order to enable the objectives, the technical solutions and the advantages of the embodiments of the present disclosure to become clearer, the technical solutions in the embodiments of the present disclosure will be clearly and completely described below with reference to the accompanying drawings in the embodiments of the present disclosure. The following embodiments are only used to illustrate the present disclosure rather than limit the scope of the present disclosure.

In the description of the present disclosure, it should be noted that the directional or positional relations indicated by the terms “up”, “down”, “front”, “back”, “left”, “right”, “vertical”, “inner”, “outer”, etc. are the directional or positional relations shown on the basis of the drawings. They are merely used for facilitating the description of the present disclosure and simplifying the description, rather than indicating or implying that the indicated device or the element must have the specific direction, as well as be constructed and operated in the specific direction. Thus, they cannot be construed as limiting the present disclosure.

In the description of the present disclosure, it should be noted that, unless otherwise clearly specified and defined, the terms “installation”, “connected”, “connection” should be understood in a broad sense, for example, it may be fixedly connected, detachably connected or integratedly connected; may be mechanically connected or electrically connected; and may be directly connected or be connected through an intermediate medium. Those of ordinary skill in the art may understand the specific meanings of the above terms in the present disclosure according to specific situations.

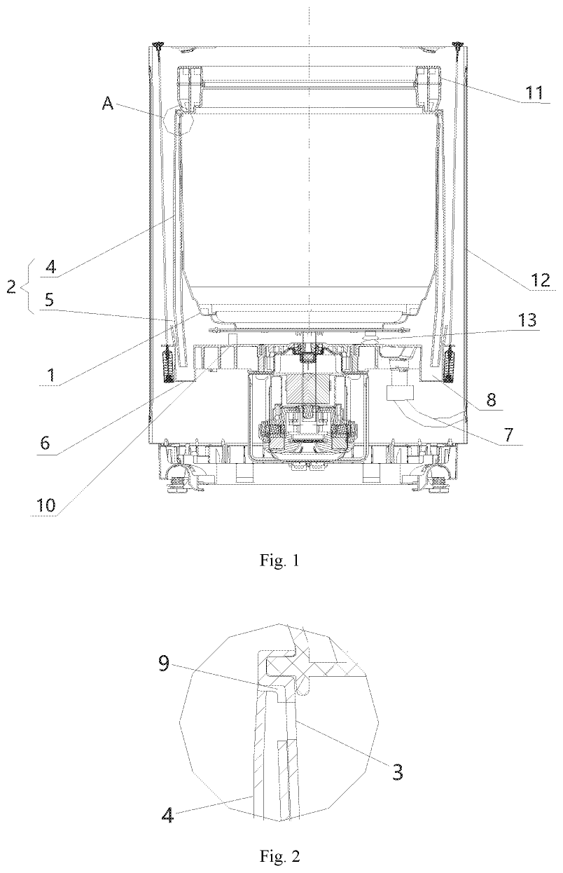

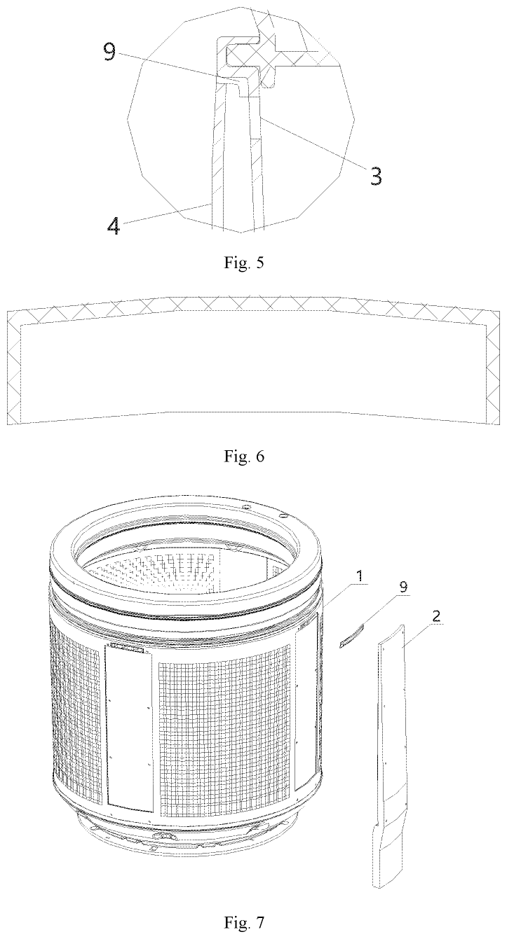

As shown in FIG. 1 to FIG. 7, a washing machine of the present disclosure includes a housing 12 of the washing machine and a washing tub 1 arranged in the housing 12, a water guide structure 2 is arranged on the tub wall of the washing tub 1 and configured to guide washing water below the washing tub 1. And a dehydration port 3 is arranged on the tub wall of the washing tub 1 corresponding to the water guide structure 2 and configured to communicate with the water guide structure 2. According to the present disclosure, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

The washing tub 1 of the present disclosure is configured to be a tub body structure for holding the washing water in the washing process; and the part of the tub wall of the washing tub 1 located below the dehydration port 3 is impermeable. In short, according to the present disclosure, the part of the washing tub 1 below the dehydration port 3 is set to be impermeable, and the outer tub arranged outside the washing tub 1 is eliminated at the same time, so that the volume of the washing tub 1 is greatly increased in the case that the outer tub is eliminated, and the single washing capacity is upgraded in the case that the housing 12 is unchanged or changes a little.

As shown in FIG. 1 and FIG. 4, the water guide structure 2 of the washing tub 1 of the washing machine of the present disclosure includes a first water guide part 4 which is closely touched with the outer side of the tub wall of the washing tub 1 and a second water guide part 5 communicated with a water outlet end of the first water guide part 4. And the second water guide part 5 guides the washing water to the lower part of the washing tub 1. The multi-segment water guide structure 2 utilizes the flow trend of the water in the washing tub 1 rotating at a high speed, thereby preventing a water flow from reversing in the drainage process and simultaneously ensuring the centralized drainage of the water flow in the drainage process.

Further, as shown in FIG. 1 and FIG. 4, a water collecting device 6 for collecting the washing water drained from the water guide structure 2 is arranged outside the bottom of the washing tub 1 of the present disclosure. An upper opening of the water collecting device 6 is lower than the dehydration port 3 of the washing tub 1. And a drainage channel 7 for draining the washing water led out by the water guide structure 2 is arranged at the water collecting device 6. After the washing water in the washing tub 1 is drained into the water collecting device 6, when the capacity achieves a certain level, the water can be drained through the drainage channel 7, and a water outlet is arranged at the bottom of the washing tub 1 corresponding to the drainage channel 7.

Even further, a water collecting groove 8 concaved is arranged at the bottom wall of the water collecting device 6; and the water collecting groove 8 is circumferentially arranged along the bottom wall of the water collecting device 6.

At the same time, during the washing operation of the washing machine, in order to ensure the normal work of the washing machine, a locking structure 10 is arranged on the water collecting device 6 outside the bottom of the washing tub 1. During washing, the locking structure 10 pops out to combine with a positioner on a flange at the bottom of the washing tub 1 to realize the locking of the washing tub 1. In addition, in order to avoid the loss of the washing water in the washing machine in the washing process, a valve plug 13 is arranged corresponding to the water outlet at the tub bottom of the washing tub 1, and in the washing operation of the washing machine, the valve plug 13 is matched with the water outlet at the bottom of the washing tub 1 to block the water outlet and prevent the washing water in the washing tub 1 from spilling.

As shown in FIG. 7, a washing machine of the present disclosure includes a water guide structure 2 being a structure of water guide chamber arranged on the tub wall of a washing tub 1 and configured to guide washing water below the washing tub 1; and a dehydration port 3 arranged on the tub wall of the washing tub 1 and configured to be communicated with the water guide structure 2. The washing tub 1 is configured to be a tub body structure for holding the washing water in the washing process; the part of the tub wall of the washing tub 1 located below the dehydration port 3 is impermeable; and the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency. Further, a sealing structure 9 is arranged between the tub wall of the washing tub 1 and the water guide structure 2 and configured to prevent the washing water from splashing via a gap between the tub wall of the washing tub 1 and the water guide structure 2.

The specific embodiments of the present disclosure are as follows:

### Embodiment 1

As shown in FIG. 1 to FIG. 7, a washing machine of the present disclosure includes a housing 12 of the washing machine and a washing tub 1 arranged in the housing 12, a water guide structure 2 is arranged on the tub wall of the washing tub 1 and configured to guide washing water below the washing tub 1, and a dehydration port 3 is arranged on the tub wall of the washing tub 1 corresponding to the water guide structure 2 and configured to be communicated with the water guide structure 2. According to the present disclosure, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

The washing tub 1 of the present disclosure is configured to be a tub body structure for holding the washing water in the washing process; and the part of the tub wall of the washing tub 1 located below the dehydration port 3 is impermeable. In short, according to the present disclosure, the part of the washing tub 1 below the dehydration port 3 is set to be impermeable, and the outer tub arranged outside the washing tub 1 is eliminated at the same time, so that the volume of the washing tub 1 is greatly increased in the case that the outer tub is eliminated, and the single washing capacity is upgraded in the case that the housing 12 is unchanged or changes a little. Further, as shown in FIG. 1, a water collecting device 6 for collecting the washing water drained from the water guide structure 2 is arranged outside the bottom of the washing tub 1 of the present disclosure. An upper opening of the water collecting device 6 is lower than the dehydration port 3 of the washing tub 1. A drainage channel 7 for draining the washing water led out by the water guide structure 2 is arranged on the water collecting device 6. After the washing water in the washing tub 1 is drained into the water collecting device 6, when the capacity achieves a certain level, the water can be drained from the drainage channel 7, and a water outlet is arranged at the bottom of the washing tub 1 corresponding to the drainage channel 7.

Even further, a water collecting groove 8 concaved is arranged on the bottom wall of the water collecting device 6; and the water collecting groove 8 is circumferentially arranged along the bottom wall of the water collecting device 6. At the same time, during the washing operation of the washing machine, in order to ensure the normal work of the washing machine, a locking structure 10 is arranged on the water collecting device 6 on the outer side of the bottom of the washing tub 1. During washing, the locking structure 10 pops out to combine with a positioner on a flange at the bottom of the washing tub 1 to realize the locking of the washing tub 1. In addition, in order to avoid the loss of the washing water in the washing machine in the washing process, a valve plug 13 is arranged corresponding to the water outlet at the tub bottom of the washing tub 1, and in the washing operation of the washing machine, the valve plug 13 is matched with the water outlet at the bottom of the washing tub 1 to block the water outlet and prevent the washing water in the washing tub 1 from spilling.

In addition, the present disclosure further includes a water guide structure 2 being a structure of water guide chamber arranged on the tub wall of a washing tub 1 and configured to guide washing water below the washing tub 1; and a dehydration port 3 arranged on the tub wall of the washing tub 1 and configured to be communicated with the water guide structure 2. The washing tub 1 is configured to be a tub body structure for holding the washing water in the washing process; the part of the tub wall of the washing tub 1 located below the dehydration port 3 is impermeable; and the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency. Further, a sealing structure 9 is arranged between the tub wall of the washing tub 1 and the water guide structure 2 and configured to prevent the washing water from splashing via a gap between the tub wall of the washing tub 1 and the water guide structure 2.

The dehydration port 3 of the washing tub 1 in the present disclosure is arranged on the tub wall of the washing tub 1 and simultaneously the water guide structure 2 is communicated with the dehydration port 3, thereby effectively utilizing the flow trend of a water flow when the washing tub 1 dehydrates and reducing the energy consumption while ensuring the functions. In the case that the volume of the housing 12 is unchanged or changes a little, the capacity of the washing tub 1 is increased, and the effect of expanding the capacity of the washing machine is realized. In the washing process, the water only exists in the washing tub 1, the problem of “hiding dirt” between the inner wall of the outer tub and the outer wall of the washing tub 1 caused by the water existence between the inner tub and the outer tub of the traditional washing machine is avoided, and the washing effect is better. The outer tub is eliminated, the washing tub 1 is a water holding tub, and the water does not exist between the inner tub and the outer tub in the washing process, thereby reducing the water consumption for washing and saving the water consumption for washing.

### Embodiment 2

As shown in FIG. 1 to FIG. 3, the present embodiment further defines the above embodiment 1, a washing tub of a washing machine of the present disclosure includes a water guide structure 2 being an independent water guide chamber structure arranged on the tub wall of a washing tub 1 and configured to guide washing water below the washing tub 1; and a dehydration port 3 arranged on the tub wall of the washing tub 1 and configured to be communicated with the water guide structure 2. Wherein, the washing tub 1 is a tub body structure for holding the washing water in the washing process; and the part of the tub wall of the washing tub 1 located below the dehydration port 3 is impermeable. In addition, the water guide structure 2 is embedded in the outer wall of the washing tub 1 and forms a smooth transitional curved surface with the outer wall of the washing tub 1. When the washing tub rotates at a high speed, the smooth transitional curved surface can effectively reduce the resistance of wind, reduce the energy consumption and improve the washing efficiency; and at the same time, the water guide structure 2 further includes a first water guide part 4 which is closely touched with the outer side of the tub wall of the washing tub 1.

Further, a second water guide part 5 communicated with a water outlet end of the first water guide part 4 is further included; and the second water guide part 5 guides the washing water to the lower part of the washing tub 1.

Even further, a water collecting device 6 for collecting the washing water drained from the water guide structure 2 is arranged outside the bottom of the washing tub 1; an upper opening of the water collecting device 6 is arranged lower than the dehydration port 3 of the washing tub 1; and a drainage channel 7 for draining the washing water led out by the water guide structure 2 is arranged on the water collecting device 6.

Still further, a water collecting groove 8 concaved is arranged on the bottom wall of the water collecting device 6; and the water collecting groove 8 is circumferentially arranged along the bottom wall of the water collecting device 6.

In the embodiment of the present disclosure, the water collecting device 6 is arranged outside the bottom of the washing tub 1, and the water guide structure 2 for guiding a water flow to the water outlet is arranged on the bottom wall of the water collecting cavity of the water collecting device 6, thereby realizing better water guiding and drainage, ensuring water collection and drainage of the water collecting device 6 and preventing the accumulated water from overflowing. The multi-segment water guide structure 2 utilizes the flow trend of the water in the washing tub 1 rotating at a high speed, thereby preventing the water flow from reversing in the drainage process and simultaneously ensuring the centralized drainage of the water flow in the drainage process. And the water guide structure 2 with the independent chamber prolongs the service life of the washing tub 1 and simultaneously facilitates the maintenance and replacement.

### Embodiment 3

As shown in FIG. 4 to FIG. 6, the present embodiment further defines the above embodiment 1, a washing tub of a washing machine of the present disclosure includes a water guide structure 2 which is arranged on the tub wall of a washing tub 1, matched with the tub wall of the washing tub 1 to form a water guide chamber structure and configured to guide washing water below the washing tub 1; and a dehydration port 3 arranged on the tub wall of the washing tub 1 and configured to be communicated with the water guide structure 2.

Wherein, the washing tub 1 is a tub body structure for holding the washing water in the washing process; and the part of the tub wall of the washing tub 1 located below the dehydration port 3 is impermeable. In addition, the water guide structure 2 is embedded in the outer wall of the washing tub 1 and forms a smooth transitional curved surface with the outer wall of the washing tub 1. When the washing tub rotates at a high speed, the smooth transitional curved surface can effectively reduce the resistance of wind, reduce the energy consumption and improve the washing efficiency. And at the same time, the water guide structure 2 further includes a first water guide part 4 which is closely touched with the outer side of the tub wall of the washing tub 1.

Further, a second water guide part 5 communicating with a water outlet end of the first water guide part 4 is further included; and the second water guide part 5 guides the washing water to the lower part of the washing tub 1.

Even further, a water collecting device 6 for collecting the washing water drained from the water guide structure 2 is arranged outside the bottom of the washing tub 1; an opening in the upper part of the water collecting device 6 is arranged below the dehydration port 3 of the washing tub 1; and a drainage channel 7 for draining the washing water led out by the water guide structure 2 is arranged on the water collecting device 6.

Still further, a water collecting groove 8 concaved is arranged on the bottom wall of the water collecting device 6; and the water collecting groove 8 is circumferentially arranged along the bottom wall of the water collecting device 6.

In the embodiment of the present disclosure, the water collecting device 6 is arranged outside the bottom of the washing tub 1, and the water guide structure 2 for guiding a water flow to the water outlet is arranged on the bottom wall of the water collecting cavity of the water collecting device 6, thereby realizing better water guiding and drainage, ensuring water collection and drainage of the water collecting device 6 and preventing the accumulated water from overflowing. The multi-segment water guide structure 2 utilizes the flow trend of the water in the washing tub 1 rotating at a high speed, thereby preventing the water flow from reversing in the drainage process and simultaneously ensuring the centralized drainage of the water flow in the drainage process. And the first water guide part 4 of the water guide structure 2 is combined with the tub wall of the washing tub 1 to form the water guide chamber, thereby effectively reducing the situation that the washing water in the tub splashes via the gap between the water guide structure 2 and the tub wall of the washing tub 1 in the process of the dehydration operation.

### Embodiment 4

As shown in FIG. 1 to FIG. 7, the present embodiment further defines any embodiment of the above Embodiment 1 to Embodiment 3, a washing machine of the present embodiment includes a water guide structure 2 being a water guide chamber structure arranged on the tub wall of a washing tub 1 and configured to guide washing water below the washing tub 1; a dehydration port 3 arranged on the tub wall of the washing tub 1 and configured to communicate with the water guide structure 2; and a sealing structure 9 arranged between the tub wall of the washing tub 1 and the water guide structure 2 and configured to prevent the washing water from splashing via a gap between the tub wall of the washing tub 1 and the water guide structure 2.

Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

Further, the water guide structure 2 further includes a first water guide part 4 which is closely touched with the outer side of the tub wall of the washing tub 1.

Even further, a second water guide part 5 communicated with a water outlet end of the first water guide part 4 is further included; and the second water guide part 5 guides the washing water to the lower part of the washing tub 1.

Furthermore, a water collecting device 6 for collecting the washing water drained from the water guide structure 2 is arranged outside the bottom of the washing tub 1; an upper opening of the water collecting device 6 is lower than the dehydration port 3 of the washing tub 1; and a drainage channel 7 for draining the washing water led out by the water guide structure 2 is arranged on the water collecting device 6.

Further, a water collecting groove 8 concaved is arranged on the bottom wall of the water collecting device 6; and the water collecting groove 8 is circumferentially arranged along the bottom wall of the water collecting device 6.

Even further, the second water guide part 5 of the water guide structure 2 guides the washing water in the washing tub 1 into the water collecting groove 8.

The dehydration port 3 of the washing tub 1 of the washing machine in the present embodiment is arranged on the tub wall of the washing tub 1 and simultaneously the water guide structure 2 is arranged to be communicated with the dehydration port 3, thereby effectively utilizing the flow trend of a water flow when the washing tub 1 dehydrates and reducing the energy consumption while ensuring the functions; in the case that the volume of the housing 12 is unchanged or changes a little, the capacity of the washing tub 1 is increased, and the effect of expanding the capacity of the washing machine is realized; in the washing process, the water only exists in the washing tub 1, the problem of “hiding dirt” between the inner wall of the outer tub and the outer wall of the washing tub 1 caused by the water existence between the inner tub and the outer tub of the traditional washing machine is avoided, and the washing effect is better. The outer tub is eliminated, the washing tub 1 is a water holding tub, and the water does not exist between the inner tub and the outer tub in the washing process, thereby reducing the water consumption for washing and saving the water consumption for washing. The water guide structure 2 for guiding the water flow to the water outlet is arranged on the bottom wall of the water collecting cavity of the water collecting device 6, thereby realizing better water guiding and drainage, ensuring water collection and drainage of the water collecting device 6 and preventing the accumulated water from overflowing. The multi-segment water guide structure 2 utilizes the flow trend of the water in the washing tub 1 rotating at a high speed, thereby preventing the water flow from reversing in the drainage process and simultaneously ensuring the centralized drainage of the water flow in the drainage process. The sealing structure 9 is arranged between the water guide structure 2 and the tub wall of the washing tub 1, thereby effectively reducing the situation that the washing water in the tub splashes via the gap between the water guide structure 2 and the tub wall of the washing tub 1 in the process of the dehydration operation.

### Embodiment 5

As shown in FIG. 1 to FIG. 7, the present embodiment further limits any embodiment of Embodiment 1 to Embodiment 4, a water guide structure 2 of a washing machine of the present embodiment is a water guide chamber structure arranged on the tub wall of a washing tub 1 and configured to guide washing water below the washing tub 1; and a dehydration port 3 arranged on the tub wall of the washing tub 1 and configured to be communicated with the water guide structure 2. Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

Further, the water guide structure 2 further includes a first water guide part 4 which is closely touched with the outer side of the tub wall of the washing tub 1, the distance between the outer wall of the first water guide part 4 and the axis of the washing tub 1 increases gradually in the direction from the top to the bottom of the washing tub 1. During the dehydration operation of the washing machine, the situation that the water flows back to the interior of the washing tub 1 along the outer wall of the water guide structure 2 when the washing tub 1 rotates at a high speed is effectively avoided. Even further, a second water guide part 5 communicated with a water outlet end of the first water guide part 4 is further included; and the second water guide part 5 guides the washing water to the lower part of the washing tub 1.

### Embodiment 6

As shown in FIG. 1 to FIG. 7, the present embodiment further limits any embodiment of Embodiment 1 to Embodiment 4, a water guide structure 2 of a washing machine of the present embodiment is arranged on the tub wall of a washing tub 1, touched with the tub wall of the washing tub 1 to form a water guide chamber structure and configured to guide washing water below the washing tub 1; and a dehydration port 3 arranged on the tub wall of the washing tub 1 and configured to be communicated with the water guide structure 2.

Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

Further, the water guide structure 2 further includes a first water guide part 4 which is closely touched with the outer side of the tub wall of the washing tub 1, the distance between the outer wall of the first water guide part 4 and the axis of the washing tub 1 tends to increase gradually in the direction from the top to the bottom of the washing tub 1. During the dehydration operation of the washing machine, the situation that the water flows back to the interior of the washing tub 1 along the outer wall of the water guide structure 2 when the washing tub 1 rotates at a high speed is effectively avoided; even further, a second water guide part 5 communicating with a water outlet end of the first water guide part 4 is further included; and the second water guide part 5 guides the washing water to the lower part of the washing tub 1.

In addition, the distance between the outer wall of the second water guide part 5 and the axis of the washing tub 1 tends to decrease gradually in the direction from the top to the bottom of the washing tub 1. This arrangement effectively ensures the trend of flowing towards to the axial direction of the washing tub 1 when the water is drained from the second water guide part 5 and avoids the situation that the water is splashed from the water collecting structure and pollutes the internal environment of the washing machine.

### Embodiment 7

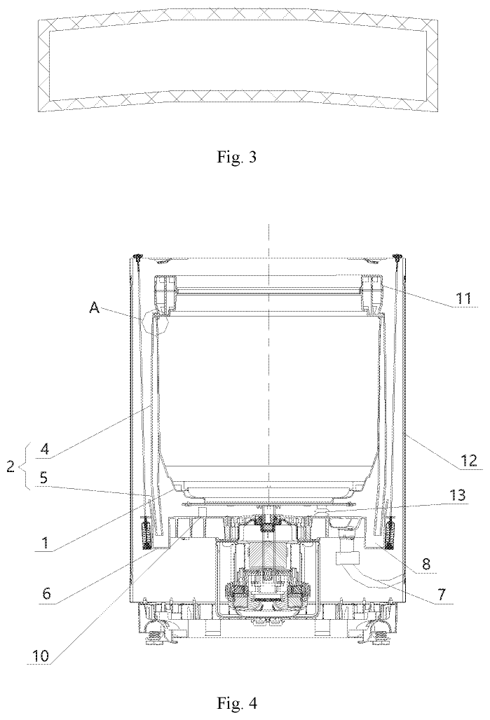

As shown in FIG. 3 to FIG. 6, the present embodiment further limits the above Embodiment 6, a water guide structure 2 of a washing machine of the present embodiment is arranged on the tub wall of a washing tub 1, touched with the tub wall of the washing tub 1 to form a water guide chamber structure and configured to guide washing water below the washing tub 1; and a dehydration port 3 is arranged on the tub wall of the washing tub 1 and configured to be communicated with the water guide structure 2.

Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

Further, the water guide structure 2 further includes a first water guide part 4 which is closely touched with the outer side of the tub wall of the washing tub 1, the distance between the outer wall of the first water guide part 4 and the axis of the washing tub 1 tends to increase gradually in the direction from the top to the bottom of the washing tub 1. During the dehydration operation of the washing machine, the situation that the water flows back to the interior of the washing tub 1 along the outer wall of the water guide structure 2 when the washing tub 1 rotates at a high speed is effectively avoided; even further, a second water guide part 5 communicated with a water outlet end of the first water guide part 4 is further included; and the second water guide part 5 guides the washing water to the lower part of the washing tub 1.

In addition, the distance between the outer wall of the second water guide part 5 and the axis of the washing tub 1 tends to decrease gradually in the direction from the top to the bottom of the washing tub 1. This arrangement effectively ensures the trend of flowing towards to the axial direction of the washing tub 1 when the water is drained from the second water guide part 5 and avoids the situation that the water is splashed from the water collecting structure and pollutes the internal environment of the washing machine.

In addition, the inner wall of the second water guide part 5 of the present embodiment is connected with the outer wall of the washing tub 1 to form an independent sealed water guide chamber.

Furthermore, a water collecting device 6 for collecting the washing water drained from the water guide structure 2 is arranged outside the bottom of the washing tub 1; an upper opening of the water collecting device 6 is lower than the dehydration port 3 of the washing tub 1; and a drainage channel 7 for draining the washing water led out by the water guide structure 2 is arranged on the water collecting device 6.

Further, a water collecting groove 8 concaved is arranged on the bottom wall of the water collecting device 6; and the water collecting groove 8 is circumferentially arranged along the bottom wall of the water collecting device 6.

Still further, the second water guide part 5 of the water guide structure 2 guides the washing water in the washing tub 1 into the water collecting groove 8.

### Embodiment 8

As shown in FIG. 7, the present embodiment further limits any embodiment of the above Embodiment 1 to Embodiment 7, a washing machine of the present embodiment includes a water guide structure 2 being a water guide chamber structure arranged on the tub wall of a washing tub 1 and configured to guide washing water below the washing tub 1; a dehydration port 3 arranged on the tub wall of the washing tub 1 and configured to be communicated with the water guide structure 2; and a sealing structure 9 arranged between the tub wall of the washing tub 1 and the water guide structure 2 and configured to prevent the washing water from splashing via a gap between the tub wall of the washing tub 1 and the water guide structure 2. Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

At the same time, the sealing structure 9 is annularly arranged on the edge of the dehydration port 3 and configured to ensure that a water guide chamber of the water guide structure 2 is connected with the dehydration port 3 of the washing tub 1 in a sealed manner, so as to prevent the washing water from splashing via a gap between the dehydration port 3 of the washing tub 1 and the water guide structure 2.

### Embodiment 9

As shown in FIG. 7, the present embodiment further limits any embodiment of the above Embodiment 1 to Embodiment 7, a washing machine of the present embodiment includes a water guide structure 2 being a water guide chamber structure arranged on the tub wall of a washing tub 1 and configured to guide washing water to the lower part of the washing tub 1; a dehydration port 3 arranged on the tub wall of the washing tub 1 and configured to be communicated with the water guide structure 2; and a sealing structure 9 arranged between the tub wall of the washing tub 1 and the water guide structure 2 and configured to prevent the washing water from splashing via a gap between the tub wall of the washing tub 1 and the water guide structure 2. Wherein, the washing tub 1 is a tub body structure for holding the washing water in the washing process; and the part of the tub wall of the washing tub 1 located below the dehydration port 3 is impermeable.

In addition, the water guide structure 2 is embedded in the outer wall of the washing tub 1 and forms a smooth transitional curved surface with the outer wall of the washing tub 1. When the washing tub 1 rotates at a high speed, the smooth transitional curved surface can effectively reduce the resistance of wind, reduce the energy consumption and improve the washing efficiency.

In addition, the sealing structure 9 is annularly arranged at the edge of the structure of the water guide structure 2 embedded into the tub wall of the washing tub 1 and configured to prevent the washing water from splashing via the gap of the water guide structure 2 embedded into the tub wall of the washing tub 1.

### Embodiment 10

As shown in FIG. 7, the present embodiment further limits any embodiment of the above Embodiment 9 to Embodiment 10, and the sealing structure 9 of the present embodiment is a sealing ring annularly arranged at the edge of the dehydration port 3.

### Embodiment 11

As shown in FIG. 7, the present embodiment further limits any embodiment of the above Embodiment 9 to Embodiment 10, and the sealing structure 9 of the present embodiment is a sealant annularly arranged at the edge of the dehydration port 3.

### Embodiment 12

As shown in FIG. 1 to FIG. 7, the present embodiment further limits any embodiment of the above Embodiment 1 to Embodiment 11, a water collecting device 6 for collecting the washing water drained from the water guide structure 2 is arranged outside the bottom of the washing tub 1; an upper opening of the water collecting device 6 is lower than the dehydration port 3 of the washing tub 1; and a drainage channel 7 for draining the washing water led out by the water guide structure 2 is arranged on the water collecting device 6.

Even further, a water collecting groove 8 concaved is arranged on the bottom wall of the water collecting device 6; and the water collecting groove 8 is circumferentially arranged along the bottom wall of the water collecting device 6. The water guide structure 2 for guiding the water flow to the water outlet is arranged on the bottom wall of a water collecting cavity of the water collecting device 6 of the present disclosure, thereby realizing better water guiding and drainage, ensuring water collection and drainage of the water collecting device 6 and preventing the accumulated water from overflowing.

### Embodiment 13

As shown in FIG. 1 to FIG. 7, the present embodiment further limits the above Embodiment 12, and the upper edge of the water collecting groove 8 of the present embodiment is higher than the water outlet end of the second water guide part 5, thereby effectively preventing the washing water from splashing from the water collecting device 6 and causing the pollution to the internal space of the washing machine when the washing water is drained from the second water guide part 5.

### Embodiment 14

As shown in FIG. 1 to FIG. 7, the present embodiment further limits any embodiment of the above Embodiment 12 to Embodiment 13, the upper edge of the water collecting groove 8 is not higher than a position of one half of the height of the washing tub 1 from the bottom to the top. The present embodiment eliminates the structure of the outer tub of the washing machine, in the case that the volume of the housing 12 is unchanged or changes a little, the capacity of the washing tub 1 is increased, and the effect of expanding the capacity of the washing machine is realized. In the washing process, the water only exists in the washing tub 1, the problem of “hiding dirt” between the inner wall of the outer tub and the outer wall of the washing tub 1 caused by the water existence between the inner tub and the outer tub of the traditional washing machine is avoided, and the washing effect is better. And the outer tub is eliminated, the washing tub 1 is a water holding tub, and the water does not exist between the inner tub and the outer tub in the washing process, thereby reducing the water consumption for washing and saving the water consumption for washing.

### Embodiment 15

As shown in FIG. 1 to FIG. 7, the present embodiment further limits any embodiment of the above Embodiment 12 to Embodiment 14, and the water collecting device 6 is located below the washing tub 1 and coaxially arranged with the washing tub 1. In the dehydration operation process of the washing machine, the excessive centrifugal force caused by eccentricity is effectively reduced, which reduces the service life of the washing machine.

In the description provided herein, a lot of specific details are illustrated. However, it can be understood that the embodiments of the present disclosure can be practiced without these specific details. In some instances, the known methods, structures and technologies are not illustrated in detail so as not to obscure the understanding of the present description.

Similarly, it should be understood that in order to simplify the present disclosure and help understand one or more of the various inventive aspects, in the above description of the exemplary embodiments of the present disclosure, the various features of the present disclosure are sometimes grouped together into a single embodiment, drawing or its description. However, the disclosed method should not be construed as reflecting the following intent: the claimed present disclosure requires more features than those explicitly stated in each claim. More precisely, as reflected in the following claims, the inventive aspects lie in less than all the features of a single embodiment disclosed previously. Thus, the claims following the specific embodiments are thus explicitly incorporated into the specific embodiments, wherein each claim itself serves as a separate embodiment of the present disclosure.

Except that at least some of such features and/or processes or units are mutually exclusive, any combination can be used to combine all the features disclosed in the present disclosure (including the accompanying claims, abstract and drawings) and any method or all the processes or units of the equipment disclosed in this manner. Unless expressly stated otherwise, each feature disclosed in the present description (including the accompanying claims, abstract and drawings) may be replaced by an alternative feature providing the same, equivalent or similar purpose.

In addition, those skilled in the art can understand that although some embodiments described herein include certain features included in other embodiments but not other features, the combination of features of different embodiments means that the features are within the scope of the present disclosure and the different embodiments are formed. For example, in the following claims, any one of the claimed embodiments can be used in any combination.

It should be noted that the above embodiments are used to illustrate rather than limit the present disclosure, and those skilled in the art can design alternative embodiments without departing from the scope of the appended claims. In the claims, any reference signs placed between parentheses should not be constructed as limitations to the claims. The word “including” does not exclude the presence of elements or steps not listed in the claims. The word “a” or “an” preceding an element does not exclude the presence of multiple elements. In the unit claims enumerating several devices, several of these devices may be embodied in the same hardware item. The use of the words first, second, third and the like do not indicate any order. These words can be interpreted as names.

The above embodiments are only the preferred embodiments of the present disclosure and do not limit the present disclosure in any form. Although the present disclosure has been disclosed as above in the preferred embodiments, the preferred embodiments are not intended to limit the present disclosure. Any technician familiar with this patent can use the technical contents suggested above to make slight changes or modifications to form the equivalent embodiments with equivalent changes without departing from the technical solution of the present disclosure. For any contents that do not depart from the technical solution of the present disclosure, any simple modifications, equivalent changes and modifications to the above embodiments according to the technical essence of the present disclosure still fall within the scope of the solutions of the present disclosure.

1. A washing machine, comprising:
a water guide structure, being a water guide chamber arranged on a tub wall of a washing tub and configured to guide washing water below the washing tub;
a dehydration port, arranged on the tub wall of the washing tub and configured to be communicated with the water guide structure; and
a sealing structure, arranged between the tub wall of the washing tub and the water guide structure and configured to prevent the washing water from splashing via a gap between the tub wall of the washing tub and the water guide structure.

2. The washing machine according to claim 1, wherein,
the washing tub is configured to be a tub body for holding the washing water in the washing process; and
a part of the tub wall of the washing tub below the dehydration port is impermeable.

3. The washing machine according to claim 1, wherein the water guide structure is embedded in an outer wall of the washing tub and forms a smooth transitional curved surface with the outer wall of the washing tub.

4. The washing machine according to claim 3, wherein,
the water guide structure comprises a first water guide part closely touched with an outer side of the tub wall of the washing tub.

5. The washing machine according to claim 4, further comprising:
a second water guide part, communicated with a water outlet end of the first water guide part; wherein
the second water guide part guides the washing water below the washing tub.

6. The washing machine according to claim 1, wherein,
the sealing structure is annularly arranged at an edge of the dehydration port, and configured to ensure that the water guide chamber of the water guide structure is connected with the dehydration port of the washing tub in a sealed manner to prevent the washing water from splashing via a gap between the dehydration port of the washing tub and the water guide structure.

7. The washing machine according to claim 1, wherein,
the sealing structure is annularly arranged at the edge of the water guide structure embedded into the tub wall of the washing tub and configured to prevent the washing water from splashing via a gap between the water guide structure embedded into the tub wall of the washing tub and the washing tub.

8. The washing machine according to claim 1, comprising
a water collecting device for collecting the washing water drained from the water guide structure, arranged outside a bottom of the washing tub; wherein
an upper opening of the water collecting device is lower than the dehydration port of the washing tub;
a drainage channel for draining the washing water guided out by the water guide structure, arranged on the water collecting device.

9. The washing machine according to claim 8, wherein,
a water collecting groove concaved is arranged on a bottom wall of the water collecting device; and
the water collecting groove is circumferentially arranged along the bottom wall of the water collecting device.

10. The washing machine according to claim 9, wherein,
a second water guide part of the water guide structure guides the washing water in the washing tub into the water collecting groove.

11. The washing machine according to claim 4, wherein a distance between an outer wall of the first water guide part and an axis of the washing tub increases gradually in a direction from a top to a bottom of the washing tub.

12. The washing machine according to claim 5, wherein a distance between an outer wall of the second water guide part and the axis of the washing tub decreases gradually in the direction from the top to the bottom of the washing tub.

13. The washing machine according to claim 6, wherein the sealing structure is a sealing ring annularly arranged at the edge of the dehydration port.

14. The washing machine according to claim 7, wherein the sealing structure is a sealing ring annularly arranged at the edge of the dehydration port.

15. The washing machine according to claim 8, wherein the water collecting device is located below the washing tub and coaxially arranged with the washing tub.

16. The washing machine according to claim 10, wherein an upper edge of the water collecting groove is higher than a water outlet end of the second water guide part.

17. The washing machine according to claim 10, wherein the upper edge of the water collecting groove is not higher than a position of one half of the height of the washing tub.
